(19) United States
(12) Patent Application Publication
(10) Pub. No.: US 2014/0218356 A1
(43) Pub. Date: Aug. 7, 2014

(54) METHOD AND APPARATUS FOR SCALING IMAGES

(71) Applicant: Joshua D.I. Distler, Brooklyn, NY (US)

(72) Inventor: Joshua D.I. Distler, Brooklyn, NY (US)

(21) Appl. No.: 14/173,719

(22) Filed: Feb. 5, 2014

Related U.S. Application Data
(60) Provisional application No. 61/761,609, filed on Feb. 6, 2013.

(51) Int. Cl. G06T 19/20

(52) U.S. Cl. CPC G06T 19/20
USPC 345/419

(57) ABSTRACT

The invention described herein allows a user to create their own artwork using existing artwork authoring tools and then apply it to the surface of a 3D object. In one embodiment, the user places artwork on a 2D layout of the 3D object. In another embodiment, the user may adjust the size of the object by applying scaling factors to the 2D layout. An imaging application then scales all areas of the 2D layout according to their connectivity to other surfaces of the 3D object.

### CROSS-REFERENCE TO RELATED APPLICATIONS

This application claims the benefit of U.S. Provisional Application No. 61/761,609, filed Feb. 6, 2013, which is hereby incorporated by reference in its entirety.

### BACKGROUND OF THE INVENTION

1. Field of the Invention

The present invention relates to the field of image generation. More particularly, the present invention relates to methods and apparatus for generating images with photorealistic imagery.

2. Discussion of the Background

While imaging software can dramatically accelerate a user's ability to quickly and easily apply their artwork to a photographic scene or object and have it depicted photo-realistically, there is some room in the prior art to further accelerate workflow.

Specifically, there are some workflow limitations experienced by authors of creative works such as graphic designers or advertising designer (“creatives”). Creatives often have need to visualize specific ink treatments so that they can effective understand what their design will look like when completed or communicate that design more accurately to a client. Creating ink effects is currently possible using a number of manual tools but is extremely time consuming and requires an expert skill set. Furthermore, the effect is inconsistent and ranges in quality based on the individual creator. Ink effects can be created using 2D software but the creation process is similar to that of manually painting to create the look. Ink effects can also be created using 3D software but the tools are complex and rendering can be time consuming and applying a number of ink effects to artwork can take hours of time.

Creatives often need to visualize their ideas on very specific formats due to project budget or specialized restrictions. A designer may need to show their design idea on a box with specific dimensions, designed to pack into a palette for shipping, for example. The design can create the box by hand, cutting and pasting it together and then shooting an image of the box; they can create it using 2D software but the process is either extremely time consuming or yields a substandard result. They can create a specific format using 3D software but the process is time consuming and the application of user artwork can take as much time as creating the surface itself, often hours.

One method of providing artwork a 3D surface is described, for example, in co-owned U.S. Pat. No 8,130,238 to Distler (“Distler”) which is hereby incorporated by reference in its entirety. Distler describes providing a user with a 3D image of an object and with a 2D map of the surface of that object. A user may place artwork on the 2D map, and the software applies the artwork on the 3D image. In this way, the user may easily see how a 3D object appears with the artwork. The user can also move, scale, or otherwise reposition the artwork on the 2D map and visualize what this will look like from the 3D image.

While imaging software can dramatically accelerate a user's ability to quickly and easily apply their artwork to a photographic scene or object and have it depicted photo-realistically, there is some room in the prior art to further accelerate workflow.

While prior art software has some capabilities useful to creatives, there is a need for a method and system of allowing a user to scale and object, sometimes to a specific size, independent of the artwork to facilitate the design process.

### BRIEF SUMMARY OF THE INVENTION

The invention allows its user to create their artwork using existing artwork authoring tools and then apply it with a single-click through the automation of our invention. Inks are simulated using user-created artwork and completely adjustable in real-time with a single click. Adjustments to surfaces (such as the box example given above) are possible by simply entering in a new size. Our invention effectively reduces hours of work to a few seconds of clicking at a huge benefit to the user.

BRIEF SUMMARY OF THE INVENTION

The present invention overcomes the disadvantages of prior art by allowing a user to place and adjust artwork on a 2D layout of a 3D object.

It is one aspect of the present invention to provide a method of resizing, in an imaging application, a planar representation of a 3D object including a plurality of areas each corresponding to one of a plurality of surface areas of the 3D object, and where the imaging application has access to information regarding coincident edges and/or points of the plurality of areas based on their relationship in the 3D object. The method includes accepting a scaling parameter, where the scaling parameter corresponds to a scaling of the 3D object along an axis of the 3D object, and forming a scaled planar representation of the 3D object, where the forming includes resizing and/or translating one or more of the plurality of areas of the planar representation of a 3D object based on the information regarding coincident edges and/or points of the plurality of areas.

It is one aspect of the present invention to provide a method of resizing, in an imaging application, a planar representation of a 3D object including a plurality of areas each corresponding to one of a plurality of surface areas of the 3D object, and where the imaging application has access to information regarding coincident edges and/or points of the plurality of areas based on their relationship in the 3D object. The method includes accepting a scaling parameter, where the scaling parameter corresponds to a scaling of the 3D object along an axis of the 3D object, and forming a scaled planar representation of the 3D object, where the forming includes resizing and/or translating one or more of the plurality of areas of the planar representation of a 3D object based on the information regarding coincident edges and/or points of the plurality of areas.

It is another aspect of the present invention to provide a computer programmed to execute a program to read a file comprising information including: 1) information regarding spacing of points and/or edges of a plurality of planar shapes, where each of the planar shapes corresponds to an area of 3D object, and 2) information relating coincident points and/or edges for one of the plurality of planar shapes with at least one other planar shape of the plurality of shapes, and to display the planar representation of the 3D object on a computer display.

These features together with the various ancillary provisions and features which will become apparent to those skilled in the art from the following detailed description, are attained by the method and apparatus of the present invention, preferred embodiments thereof being shown with reference to the accompanying drawings, by way of example only, wherein:

### BRIEF DESCRIPTION OF THE SEVERAL VIEWS OF THE DRAWING

FIG. 1A is one embodiment of a computer system for viewing image files as described herein;

FIG. 1B is another embodiment of a system for viewing image files as described herein; and

FIG. 2A is a model of a 3D object;

FIG. 2B is a model of the object of FIG. 2A that is stretched in a vertical direction

FIG. 3A is a screen shot of a 2D layout of the object of FIG. 2A; and

FIG. 3B is a screen shot of a 2D layout of the object of FIG. 2B.

Reference symbols are used in the Figures to indicate certain components, aspects or features shown therein, with reference symbols common to more than one Figure indicating like components, aspects or features shown therein.

### DETAILED DESCRIPTION OF THE INVENTION

Although certain preferred embodiments and examples are disclosed below, it will be understood by those skilled in the art that the inventive subject matter extends beyond the specifically disclosed embodiments to other alternative embodiments and/or uses of the invention, and to obvious modifications and equivalents thereof. Thus it is intended that the scope of the inventions herein disclosed should not be limited by the particular disclosed embodiments described below. Thus, for example, in any method or process disclosed herein, the acts or operations making up the method/process may be performed in any suitable sequence, and are not necessarily limited to any particular disclosed sequence. For purposes of contrasting various embodiments with the prior art, certain aspects and advantages of these embodiments are described where appropriate herein. Of course, it is to be understood that not necessarily all such aspects or advantages may be achieved in accordance with any particular embodiment. Thus, for example, it should be recognized that the various embodiments may be carried out in a manner that achieves or optimizes one advantage or group of advantages as taught herein without necessarily achieving other aspects or advantages as may be taught or suggested herein. While the systems and methods discussed herein may be used for placing images so that they appear to be on three-dimensional scenes, the systems and methods can also be used in other ways: for example, to provide children's coloring-book image files with coloring areas that have 3-dimensional properties, or, for example, to provide image files for medicine where the image file will run a series of embedded edge finding and contrast enhancing effects on a user's image before scaling and masking the image for presentation in slide format.

Disclosed herein are data files, methods for generating data files, and apparatuses and methods for distributing and utilizing data files. In general, the data files are binary files that, when interpreted by an imaging application on a computer, produces an image. Such a data file is referred to herein, and without limitation, as a “file” or “image file.” Since the data contained within an image file may be used to generate an image, the terms “file containing an image,” “image file,” and “image” are sometimes used interchangeably herein.

The term “imaging application” refers, without limitation, to computer programs or systems that can display, render, edit, manipulate, and/or composite image files. Some of the discussion herein utilizes terminology regarding file formats and the manipulation or structure of file formats that is commonly used with reference to the ILLUSTRATOR® (Adobe Systems Inc., San Jose, Calif.) imaging application. It is understood that this terminology is used for illustrative purposes only, and is not meant to limit the scope of the present invention.

In general, a file containing an image has a structure and/or format that is compatible for opening or inputting to an imaging application or that may be transformed or otherwise manipulated to be opened by or otherwise inputted to an imaging applications. Thus, for example, an image file may include binary data that conforms to an image file standard including, but not limited to, a PHOTOSHOP® TIFF or native PSD format. Such a file may then be opened, for example, by an imaging application including, but not limited to, PHOTOSHOP® or ILLUSTRATOR® and generate an image including, but not limited to, an image on a computer display or printer.

In certain embodiments, the image file is a “target image” or “source image” which is adapted to accept artwork, which is referred to herein and without limitation as “artwork” or “user artwork.” The term “design application” refers, without limitation, to computer programs or systems or imaging applications utilized by a user to generate user artwork.

In another embodiment, a target image file includes embedded data that is used to distort some or all of the image or artwork provided to the target image. The embedded data, which is referred to herein, and without limitation, as “surface data,” that is multi-dimensional and may, for example, correspond to or approximates the three-dimensional shape of an image surface.

Thus, as one example that is not meant to limit the present invention, the target image is a multi-layered file. A first layer includes an object and surface data that is used to distort a scene of a second layer so that it appears on the surface of the object. Thus, for example, the first layer may contain surface data corresponding to a three-dimensional object, such as an inclined plane, cylinder, sphere, or a more complex shape, and the second layer may be adapted to accept artwork (either a raster or vector image) that will, when composited, appear as if it were on the object surface. When the first and second layer are provided to the imaging application, the application distorts the second layer according to the embedded information of the first layer, producing an image of the scene as distorted by (or wrapped about) the surface data. Thus inclined plane surface data provides perspective to the scene, while cylindrical or spherical surface data distort the scene as it would appear if wrapped about the corresponding three-dimensional surface.

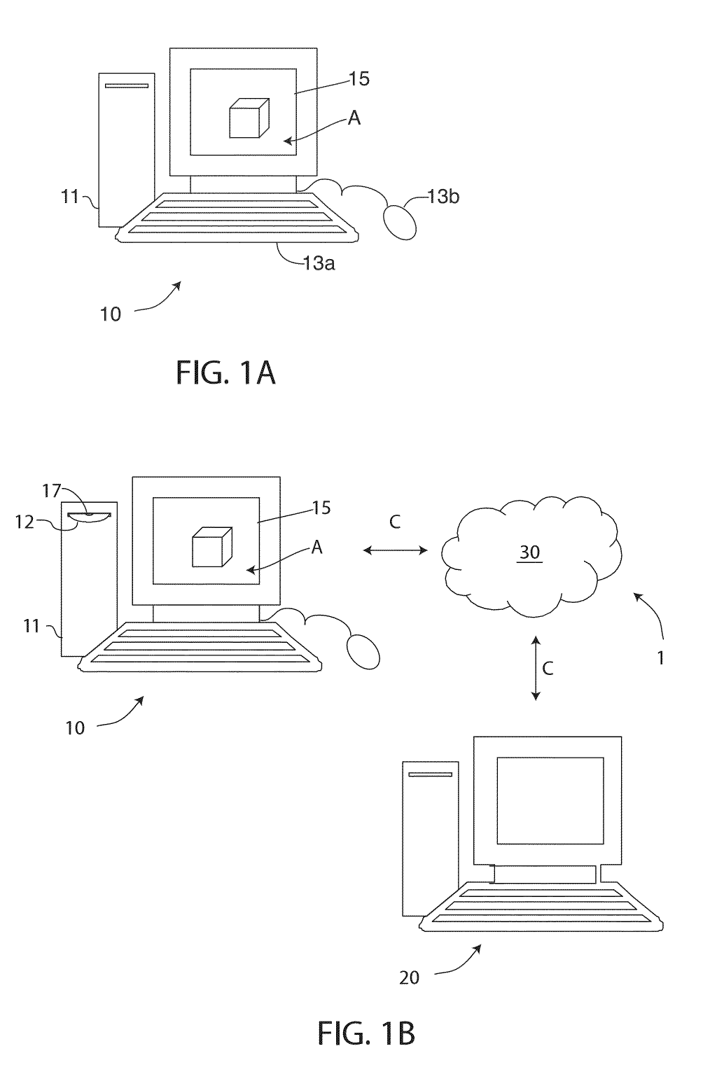

FIG. 1A is one embodiment of a computer system 10 for viewing image files as described herein. System 10 includes a processor and memory 11, one or more input devices 13, and a display 15. The input devices 13 include, but are not limited to a keyboard 13a and a graphical input device, such as a mouse 13b. Computer system 10 is particularly adapted for the production, manipulation, and or generation of images (shown, for example as image or graphical user interface (GUI) A on display 15), may also include additional devices (not shown) including but not limited to printers, additional displays, and additional or other input devices, and additional processors and/or memory. In one embodiment, computer system 10 includes the ability to execute instructions of an imaging application to generate or manipulate image files to produce images. Thus, for example and without limitation, computer, or processing system 10 and/or 20 may include computer readable hardware storage medium storing computer readable instructions that, when executed by at least one processor of a processing system, cause the processing system to carry out various methods, as described herein.

FIG. 1B is another embodiment of a system 1 for viewing image files as described herein. System 1 may be generally similar to the embodiment illustrated in FIG. 1A, except as further detailed below. Where possible, similar elements are identified with identical reference numerals in the depiction of the embodiments of FIGS. 1A and 1B.

System 1 illustrates a system for the transfer of image files or other information to or from computer system 10. As shown in FIG. 1B, system 1 also includes a second computer system 20, and a network 30. Network 30 may be, but is not limited to, combinations of one or more wired and/or wireless networks adapted to transmit information between computers and may be, without limitation, the Internet or any other communication system. Computer systems 10 and 20 may communicate through network 30, as indicated by arrows C. Communications includes, but is not limited to, e-mail or the mutual access to certain web sites. In addition, FIG. 1B also shows a removable media device 17 of computer system 10, and a removable media 12 being inserted into media device 17. Removable media 12 may be, for example and without limitation, a readable or a read-write device capable of accessing information on a CD, DVD, or tape, or a removable memory device such as a Universal Serial Bus (USB) flash drive.

In one embodiment, image files, which may contain embedded data, are provided to computer system 10 on removable media 12. In another embodiment, image files, which may contain embedded data, are provided to computer system 10 from computer system 20 over network 30.

In another embodiment, the embedded data cannot be interpreted by the imaging application without providing the imaging application with access to additional software. Thus, for example, interpretation of embedded data by the imaging application may require additional software either within, or accessible to, the imaging application. The additional software may be provided to computer system 10, either with or separate from the image file, as a software upgrade to the imaging application or as a plug-in to the imaging application. The software upgrades or plug-ins may be provided to computer system 10 through media 12 or over network 30.

In one embodiment, image file is produced entirely on computer system 10. In a second embodiment, the image file is provided to computer system 10 via media 12 or network 30. In a third embodiment, the image file is provided to computer system 10 via media 12 or network 30, and may be uses as a “template” onto which other images or artwork may be added and subsequently manipulated by the embedded data of the image file.

In certain embodiments, user artwork is processed automatically after a user-initiated event, such as a button click. The event signals the software (“processing application”) to begin processing the user's artwork and visually applying it to the surface or surfaces in the image. In one embodiment the processing application is a stand-alone software application, in other embodiments the processing application a software extension or plugin, and in other embodiments the processing application includes a multiple application group of software tools.

When signaled, the processing application, which will process the artwork into a final rendered image, communicates with the artwork creation software via any number of intra- application communication protocols. In some embodiments communication may be done via wide area network and in others it may be done via local network. In yet other embodiments it may be done via intra-application communication.

In another embodiment, the authoring software is instructed, via API calls and/or scripting to start moving user artwork (in the form of ASCII or binary data describing various combinations of vector art and raster art) to the processing application. In one embodiment, the artwork is read directly via an intra-application communication stream. In other embodiments, the artwork is read via files written temporarily to disk storage by the artwork application and read by the processing application. In yet another embodiment the artwork is read via the system clipboard.

After the initiating request, the artwork creation software is instructed to separate user artwork into groupings based on the attributes of the user artwork. In other embodiments the artwork may be sent in one group of data and assessed directly by the processing application. In some embodiments, is it necessary to have the software that created the artwork also assesses and split apart the artwork into subgroups. This may be required when the authoring application does not provide access to the complete user artwork data structure, and allows for simulation of the printing process and so that inks are applied in their natural order. Ink groupings are typically processed from the base (the first group that would be applied to paper in a real printing situation) so that the result is a process first, render first order. However, in some embodiments they may be rendered in a different order depending on hardware and software restrictions.

As each component is read from the user artwork application into the processing application, artwork is assessed for placement, rotation, scale and other qualities. In this example, one of those qualities in an associated ink color, previously assigned to the artwork object by the artwork authoring application. If it is determined that the artwork should be handled specially (by reference to lookup tables) then the processing application loads ink resource files needed to support the special handling.

The loading may happen from disk or from memory, where the ink resource files were preloaded at some point. One such file may be a metadata file containing ink attributes, where the ink matches by unique identifier from the lookup table. Another file that may be loaded by the processing application would be images related to the special handling. In one embodiment, this file may be a bump map, in another a reflection map, in another a color texture or in another a series of related images for texture, bump and reflection mapping. In some embodiments, highlight and shading images are loaded. In some, masking images are loaded. In some embodiments, depth images are used to control blurring. Any combination of bump, texture, reflection, highlight, shadow, masking or depth images may be used, depending on the desired visual attributes of the ink. In some embodiments, the resources are associated directly with an ink and in other embodiments the resources may be associated with a target image. For example, inks may have associated texture and bump maps and the target image may have associated highlight, shadow, depth and mask images.

Once loaded, the files may be used as resources for the shading process. The artwork group is rasterized into a 2D bitmap along with alpha values that determine the edges of the artwork. This bitmap data is then shaded using the appropriate loaded ink resources. For example, shading and highlight images are used as a scaling factor in taking original artwork color data and converting it.

To correctly position artwork onto the 3D surface, coordinate reference data may be included with the artwork to describe the artwork's position as it relates to the desired position within the 3D surface. In one embodiment, the positioning may be set by the user when they create their artwork in the artwork authoring software. In this embodiment, guidelines are stored within the target image file. These guidelines are a 2D representation of the surface(s) inside the target image, flattened out, similarly to how die-lines are used to describe a 3D printed box. In this embodiment, when the user originally decided to apply artwork to the target image they used the user interface to edit the target image file and the guides, the processing application then sent the artwork authoring application the guides for display during user artwork authoring. The guides serve the user as a reference for artwork placement but they are also used by the processing application to determine where on the surface(s) in the target image the user wishes to place their artwork. In other embodiments, artwork placement position may be determined by other means. For example, the user may drag their artwork content directly into the processing application and interactively position the artwork using feedback given to them as to current position (as a 2D or 3D representation) by the processing application. In other embodiments, techniques may be used to auto-detect position, such as using user-created artwork edges.

Artwork may be applied to the image using processes described in Distler. In some embodiments it is 3D transformed using a 3D wrapping process but other transforms are used, depending on the desired outcome. In some embodiments, the artwork may be transformed before the application of the ink effects while in other embodiments the ink effects will be applied before the artwork is transformed. In cases where ink effects are applied before the artwork 3D transformation occurs, the process is done using a typical 2D shading approach. In cases where the ink effects are applied after the 3D transform, the ink effects themselves must be converted to 3D space before they can be applied to the now 3D artwork.

In some embodiments, the process of rendering the artwork into the final target image is accelerated using graphical processing unit (GPU) hardware utilized by the processing application. A GPU, as will be familiar to those versed in the art, excels at working in 3D space and performing complex manipulations of a large number of pixel simultaneously. To effectively utilize the hardware, all artwork application and final bitmap image creation must happen in 3D space. Thus every pixel is displayed in 3D via 3D card hardware. Thus, for example, consider artwork that is to be applied to a wine bottle. The present invention combines a 2D mask with a 3D bottle surface to correctly transform and position user artwork to correctly appear on the bottle surface in the 2D background image. A 2D mask may be used since it may be more precisely used for applying and trimming the artwork and ensuring alignment with the background image. To accomplish 2D masking on a 3D object (the artwork, now transformed), for each artwork pixel to be displayed in 3D, the 2D position is looked up in the original image and the 2D position is used to determine a final pixel value. In some embodiments the pixel RGBA values will be modified by highlight, shading and masking values which are naturally stored as 2D raster images. After the pixel value is modified it is then written in 3D space with these RGBA values.

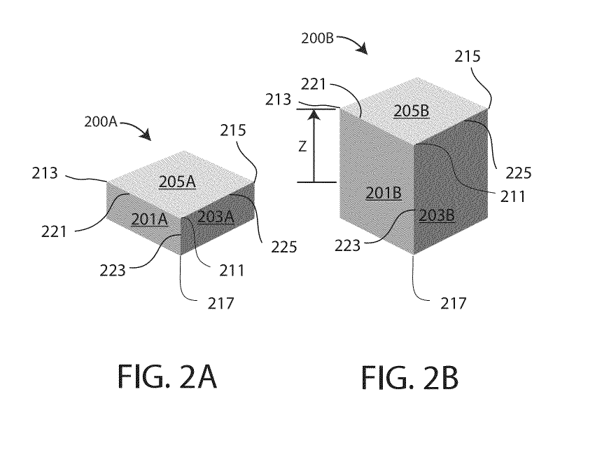

As each ink group or layer is applied to the surface, its native, color values, which come from the user's artwork itself or modified by applying shading, highlighting, bump mapping, texture, reflection maps, and so on. Two examples of a range of ink attributes are given in Distler. In FIG. 2 of Distler, block 200 represents a fluorescent ink and block 201 represents a gold foil ink. What is applied and how much is applied is typically driven by the ink attributes. For example, if the user has artwork consisting of a square with a designation of normal ink (in this example, normal ink means that no special ink effects, such as bump mapping, are used) and a circle with designation of silver chrome foil ink then two ink groups/layers are generated by the processing application. Since in the above example the square is overlaid by the circle the square is rasterized and applied first.

Because the square is designated in the artwork authoring application and recognized by the processing application as a normal ink, only highlighting and shading is done to that layer. The layer is also rendered using 100% opacity (or 1.0 value). The opacity value is also derived from values set in the ink resources and looked up by the processing application. The highlighting and shading used on the artwork layer has been derived from the source image and is applied using techniques described in 10 so the final resulting applied artwork looks photorealistic.

The circle, with its designation as silver chrome foil ink, however, receives not only highlight and shadow (with values that in some embodiments differ from those used with the square, and in other embodiments are the same) but it also receives additional rendering treatment such as reflection and bump mapping. In some embodiments 3D lighting may be used.

Ultimately the goal of these techniques is to simulate existing real-world ink processes so that as inks are printed over each other each ink takes on attributes specific to that specific ink. Inks that glow or have reflectivity that makes them return more light than a normal ink may simply receive less shading than a normal ink. When composited over a normally lit background image, the ink will then appear to glow. Normal inks composited over the same background image with normal shading will appear to be naturally lit, since the shading is (in this example) derived from the background image itself.

There is, theoretically, be an unlimited number of ink layers with artwork layers stacked one upon another, and the final rendering can appear to be very photorealistic and can well simulate the inks Having each artwork layer receive tailored treatment provides for simulating foils (with use of reflection mapping, bump maps, 3D lighting), fluorescents (by increasing highlighting and reducing shading), gloss varnishes (with reduced opacity and increased reflection mapping).

In the above example, user settings may also be used during the operation to modify the RGBA pixel values. In some embodiments, user values are used to scale the application of highlight, shadow and masking which ultimately affect the pixel RGBA values. User values may be determined by a number of factors. For example: user interface sliders, previously stored preferences, user artwork content (such as overall color saturation). In some embodiments, user values may determine the position of reflection maps, bump size, lighting angles.

Some target images may contain 3D surfaces which can be customized in both size and display angle by the user. To simplify the process of modifying the surface size, in one embodiment, the user is able to modify the size of a box interactively using height, width and depth values entered into a user interface window. The processing application handles the resizing of the 3D surfaces and their associated textures, including versions of highlight, shadow, masking, bump and blur maps. In some embodiments these assets are applied to the surface in surface space, meaning that they are applied as 3D while in other embodiments, the assets are applied to the surface in image space, meaning that they are applied as 2D, such as the process described in Distler.

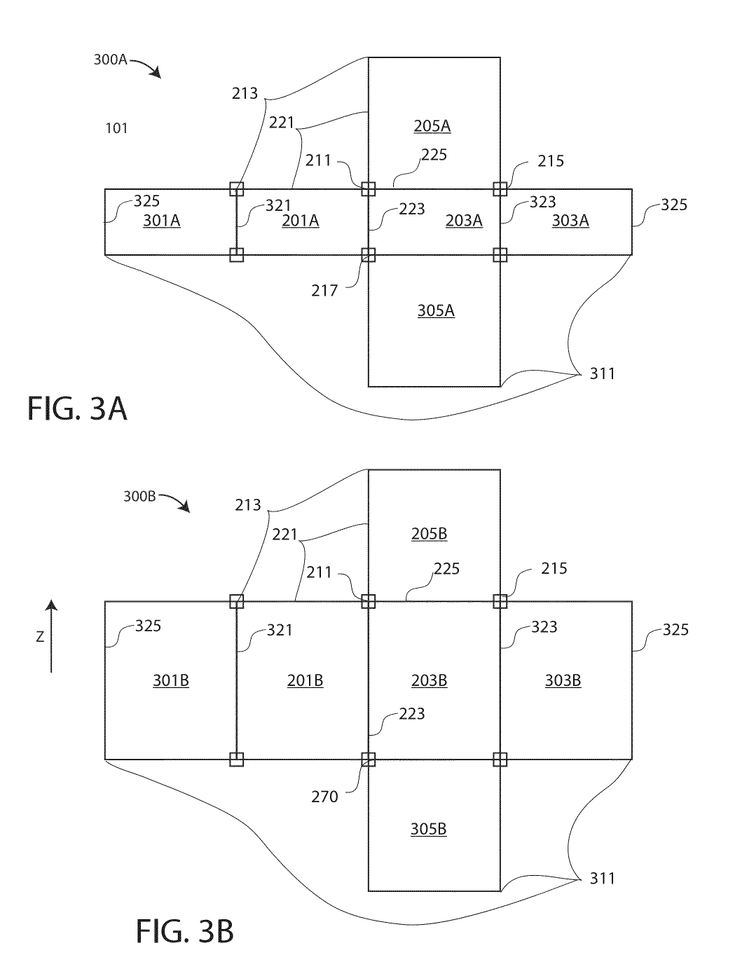

FIGS. 2A, 2B, 3A and 3B illustrate an embodiment of the present invention that permit a user to reshape and place artwork on the surfaces of 3D objects. As one embodiment, which is not meant to limit the scope of the present invention, a 3D object 200 is shown in FIG. 2A as 3D object 200A which, which is a rectangular parallelepiped, and which may be provided by an imaging application on display 15, or in memory 11. Object 200 includes 3 faces, 201, 203, and 205, that are visible in FIG. 2A as a front surface 201A, a right side 203A, and a top surface 205A, respectively. The other 3, opposing faces are not visible in FIG. 2A.

FIG. 2B shows a 3D object after being modified into 3D object 200B by being stretched along one axis by a distance Z. FIG. 2B also shows modified surfaces 201, 203, and 205 as a front surface 201B, right surface 203B, and top surface 205A. As indicated in FIGS. 2A and 2B, the modification changes the height of surfaces 201 and 203 (as well as the opposing surfaces, which are not shown in FIGS. 2A and 2B), while surface 205 shifts upwards but retains the same size.

FIGS. 3A and 3B are screen shots illustrating a planar representation of the 3D object as the 2D layout for the objects of FIGS. 2A and 2B, specifically, the screenshot of FIG. 3A is the 2D layout 300A of object 200A, and the screenshot of FIG. 3B is the 2D layout 300B of object 200B. While the same numbers are used to indicate corresponding areas, it is to be understood that, for example, surface 201 is FIGS. 2A and 2B are surface areas of a 3D object, the same surface on FIGS. 3A and 3B are planar representations as a 2D layout of those surfaces which may be guidelines for adding artwork.

The areas of the 2D layout may have the same shape as in the 3D object, or may be deformed or simplified representations of those surfaces. In one embodiment, the 2D guidelines may be a flattened 3D surface in the form of simple 2D areas. Thus the user of the guidelines may better focus on artwork placement without needing to interpret complex 2D structures that are typical of a 3D to 2D translation.

In one embodiment this simplified 2D structure is built by creating a series of 2D areas or regions (for example a 2D rectangle) that represent a flat 2D version of the 3D structure. In one embodiment, each 3D face of a box would have an associated 2D area, for a 2D structure made up of 6 2D areas. In one embodiment, these structures are manually authored: in the example of a 3D box, a series of 6 2D areas are created and positioned to in a cross-like arrangement (like that of layouts 300A and 300B). The act of drag-positioning the 2D areas, via a graphical user interface, determines the relationship that each area's corner points has to that of the other areas. This information is important during subsequent modifications and resizing. During the process of manually setting up these regions, 2D areas may be repositioned by dragging portions of the area, such as a corner point or edge, using an input device of the computer. When the corner points of a dragged 2D area (“source”) is dragged onto the corner points of another 2D area (“target”) the corner points are thus linked. The source area corner points are recorded as being linked “to” respective corner points in the target area. The target area's corner points are marked as being linked “to” the respective points of the source area and also marked as being linked “by” the source corner points. Source areas will only have “by” points and not “to” points. Effectively once all 2D areas have been linked this means that central areas will have both by and to points while outlying areas will have only by points. When the user enters new sizing values for an axis, in for example a user interface showing X Y Z axis, all of the 2D areas are first walked to check if each area has an associated 3D axis that applies to the change. If the area does have an axis that is associated with its 2D X or Y axes (for example its X=X and its Y=Z) then the size of the area is modified along the associated 2D axis (in this case, its Y axis). Once all of the relevant 2D areas have been sized the positioning of the areas must be adjusted so that the 2D positional relationship of the areas is maintained. To reposition the areas, all areas are walked to assess which areas have points that have both “by” and “to” links. These areas are repositioned first, using the change in their 2D axes as an offset value for new position. So, in the above example, where the Z value was changed and the 2D Y axis was altered the Y position of this region would be modified similarly. After areas with both by and to links are repositioned, areas with only by links are repositioned via the same Y offset. This iterative process ensures that the relationship of all 2D areas are maintained so long as they have any linked corner points. It also ensures that the structure of the 3D object continues to be accurately represented by the 2D guides. The relationship information regarding coincident lines and/or points of the 2D layout corresponding to the 3D object may be stored as metadata in a file that describes the 3D object data.

Alternatively, the metadata may be obtained from an analysis of a 3D model of the object.

FIGS. 3A and 3B also show the opposing surfaces not shown in FIGS. 2A and 2B: a back surface 303, a left side 301, and a bottom surface 305. Specifically, FIG. 3A shows the six sides of object 200A—surfaces 201A, 203A, and 205A, as shown in FIG. 2A, as well as back surface 303A, left side 301A, and bottom 305A; FIG. 3B shows the six sides of object 200B—surfaces 201B, 203B, and 205B, as shown in FIG. 2B, as well as back surface 303B, left side 301B, and bottom 305B.

In one embodiment, the resizing of the surfaces of 3D objects is performed directly on the 2D layout of the object. Thus, the changes going from 2D layout 300A to 2D layout 300B are performed by moving points or lines on the 2D layout and keeping track of the relationship of the points or lines as required for them to form the 3D object. In contrast with the prior art, the present invention does not scale the 2D layout by resizing the object in 3D, and then determining how the 2D layout appears. To accomplish this transformation, the data file for the 2D layout also contains, or has access to, information stored as metadata that indicates the relationship between lines and/or points of the 2D layout of the 3D object.

Changes to the sizes of the different surfaces of the 2D layout may be made by the imaging application using information on which points must remain bound together in the 3D object. Thus, for example, for rectangular surfaces, rectangle corner points linking may be accomplished by fixing a 2D spatial relationship between the corner points. In one embodiment, for example, the imaging application may determine which regions should be resized, and which should simply be translated to make space for the newly sized regions. If the edge length is changing due to resize then the surface is resized. If not, the surface is translated relative to the other surfaces.

As an example of the relationship data of the points and/or lines, FIG. 2A indicates just 3 of the edges and 3 of points that define the object: points 211, 213, and 215 at the meeting point of adjacent surfaces of the 3D object and lines 221, 223, and 225 at the meeting lines of adjacent surfaces. It is clear that more metadata is needed to completely define the 3D object, such as coincident edges or points between the surfaces shown and the other surfaces of the 3D object.

In certain embodiments, resizing of the 2D layout of a 3D object is performed by: 1) indicating a scaling of the object along an axis; and 2) moving the various edge and/or points of the 2D layout consistent with the 3D object.

In one embodiment, the 2D layout is used for placing artwork on the surface of the 3D object corresponding to the 2D layout. The lines of the 2D layout thus act as guidelines for the user to place artwork. In the example of FIGS. 2 and 3, 3D object 200 (which is a rectangular parallelepiped) is presented as six separate faces (201, 203, 205, 301, 303, and 305).

When a user resizes the objects, for example by increasing, from the 2D layout, the height of 3D object, many of the faces will clearly shift and/or be resized. In one embodiment the imaging application notes the relationship between the points and/or lines of the 2D layout during resizing. Thus, in one embodiment, the 2D layout information includes an indication of which corners occupy the same physical location on the 3D object. Thus, in the example of FIGS. 3A and 3B, edge 221 is common to surfaces 201 and 205, edge 223 is common to surface surfaces 201 and 203, and edge 225 is common to surfaces 203 and 205, point 211 is common to surfaces 201, 205, and 205, point 213 is common to surfaces 205, 201, and 303, point 215 is common to surfaces 203, 205, and 303, and point 311 is common to surfaces 310, 303, and 305.

In one embodiment, the imaging application uses metadata of edges and points that are coincident in the 3D model to determine how the shape of the 2D layout is modified when lines or edges of the 2D layout are changed. In one embodiment, the imaging application forms associations between the corner points of each surface, such as which points are common between different faces. This association is may be performed during the image creation process. Further, the relationship between adjacent areas can be resized by reference to metadata stored with the target image. In some embodiments, this may be the same data used by the processing application to determine which artwork section is applied to which 3D surface.

Thus, for example, if a user wishes to increase the height of a 3D object, for example as indicted by the arrow labeled Z in FIG. 2B, the user can instruct the imaging application that the height of surface 203 in the 2D layout of FIG. 3A is to be increased from the size shown as surface 203A in FIG. 3A to the size shown as surface 203B of FIG. 3B. Since this size change increases the length of edges 223 and 323, for example, the imaging application recursively adjusts each connected point. Thus, for example, the length of edge 321 is increased, since edge 321 opposes edge 223 of surface 201, and the length of edges 325 of surfaces 301 and 303 are increased, since edge 325 opposes edge 321 of surface 201 and edge 323 of surface 303. Note that the change in 2D layout may be performed directly in 2D, without reference to a stored 3D model

Note in the resizing of FIGS. 3A and 3B, surfaces 301, 201, 204, and 303 have each been stretched in one direction by the same amount. Surfaces 205 and 305 have been translated to remain connected to surface 203.

In some embodiments, after the resize event all artwork positioning values are updated so that artwork positioning will respect new guide size, locations and the new 3D surface structures.

To save storage space, the processing application may, in some embodiments, use a single master target image in order to render multiple user target images (“concept images”). Associations are made between the master target image and the associated concepts images via various metadata and used by the processing application to determine assets to load and invoke during a render operation. Because the image assets are shared between a number of concept images and managed, in one embodiment, by the processing application, a significant storage savings is achieved. Another user advantage is that concept images only contain artwork data (typically both 2D source data and 2D rendering preview data; 3D data is created on demand) as well as metadata (typically containing settings values and information which associates artwork, concept image and target image assets) and don't need to contain background images, highlight, shadow, masking, depth or other images needed by the processing application to create a rendering. This means that sharing and editing the concept images is much more convenient that sharing the target image. It also ensures that the processing application is able to manage the target image well, effectively controlling unauthorized copying or use of the target image.

### More Detailed Example of One Embodiment of the Invention

1.A graphics card is used, via an industry-standard API such as e.g. OpenGL, to composite additional imagery (organized in one or more layers), over an existing photograph, while maintaining the photograph perspective:

The existing photograph is associated with a 3D representation of the relevant parts of the photograph, in as such ‘relevant’ identifies the portions of the photograph where additional imagery may be rendered.

The 3D representation is expressed in a format that may be sent directly to OpenGL, such as a collection of polygons or higher-order surfaces. This representation is organized in one or more independent surfaces, corresponding to the visually-separated relevant portions as described earlier. At least one such surface exists per 3D representation.

The existing photograph itself, and one or more mask or shadow images, is first displayed via OpenGL in an off-screen buffer as a 2D object. A background color, with or without transparency, may be displayed in the off-screen buffer prior to displaying the existing photograph.

The 3D representation is then displayed via OpenGL, in the same off-screen buffer, with dynamically-generated shaders: for each surface, and each layer of additional imagery, the shaders compute the final pixel color—per each pixel covered by the 3D representation—according to the 2D contents and positions of the additional imagery layer, and the image masks described earlier.

The individual layers of additional imagery are represented in a standard vector format such as e.g. PDF: each layer may be assigned a specific “ink”, and it is rasterized from vector to bitmap format before being displayed by the shaders described earlier.

The off-screen buffer used by the rendering operations is then composited with any optional non-mask images associated with the existing photograph, such as e.g. an additional, partly-transparent photograph or vignette image.

Finally, the off-screen buffer is extracted from the graphics card via OpenGL, and it is converted to an image in an industry-standard format, such as e.g. TIFF or PNG, then written out to disk as the result of the rendering operation.

2. A shader is executed on the graphics card is used to display specific “ink” effects on a 3D surface, via an industry-standard API such as e.g. OpenGL:

The shader is dynamically-generated as described above, according to the layer of additional imagery that is supposed to render.

The shader uses specific calculations to derive the physical size, expressed in number of pixels, for both the additional imagery as well as the specific “ink” default images (if any).

If the layer of additional imagery is not assigned any specific “ink” effect, its contents are composited in the off-screen buffer described herein. after applying a highlight and a shadow effect. These effects are a property of the 3D representation described herein may be applied dependently on the compositing mode chosen for the layer of additional imagery. The effects may be represented via special kinds of images or of shader calculations.

If a layer of additional imagery is assigned a specific “ink” effect, its contents may be transformed by a number of industry-standard graphics techniques, such as e.g. environment mapping, bump mapping, lighting, and so on. Each specific “ink” is assigned a unique ID and set of properties, and optionally a default image, not related to the additional imagery. This default image may be combined, on a pixel level, with the contents of the layer of additional imagery, in order to achieve a variety of blending effects.

The final combination of the layer of additional imagery with the specific “ink” default image (if any) constitutes the rendering result for this pixel belonging to the 3D representation described earlier.

3. A shader is executed on the graphics card computes the additional imagery physical size and position, as well as any specific “ink” default images size and position:

The shader uses the 3D representation described herein to determine the current physical size, expressed in number of pixels, to be rendered.

The 3D representation, for each individual 3D surface that may be assigned additional imagery, contains 2D bounding information about a region that the additional imagery may be placed in. This region matches the 2D size and position of the additional imagery to the 3D surface.

The shader adjusts the size of the bounding region according to the rendering output size, and it adjusts the additional imagery size and position accordingly.

The bounding region itself may have been resized and repositioned, in the case of existing photographic imagery that may be resized and/or rotated. This bounding region resized and reposition calculation uses a dedicated method, described below.

The size of the bounding region is used to adjust the specific “ink” default images size and position (if any), such that the same “ink” image output is maintained independently of the rendering output size.

The bounding region is then returned as the result of the computation.

4. A 2D bounding region is resized and repositioned, according to a 3D resize and reposition operation:

The 3D representation described above may be specially crafted such that it can be resized and/or repositioned rotated freely in 3D. In this case, users are allowed to apply resize and reposition/rotate in real-time as they see fit. Reposition and rotate operations do not affect the 2D bounding regions, since the 3D surfaces do not change.

When a resize operation occurs for the 3D surfaces, the 2D bounding regions must be modified accordingly, otherwise they could not be used as guides during the creation of the additional imagery.

Each 2D bounding region associated to a 3D surface is assigned information about what axis the 3D surface is aligned to, as well as what other 2D bounding regions (if any) are physically linked to this region.

If a resize occurs along an axis which the 2D bounding region is aligned to (via its 3D surface), the region is repositioned along the 2D plane accordingly to the physical links (if any) with other bounding regions: physical links are always maintained with the specified proportions, such that all 2D bounding regions behave the same during a resize operation, keeping their relative positions invariant.

The final size and position of the 2D bounding region may then be returned as the rendering.

One embodiment of each of the methods described herein is in the form of a computer program that executes on a processing system, e.g., a one or more processors that are part of a computer system. Thus, as will be appreciated by those skilled in the art, embodiments of the present invention may be embodied as a method, an apparatus such as a special purpose apparatus, an apparatus such as a data processing system, or a carrier medium, e.g., a computer program product. The carrier medium carries one or more computer readable code segments for controlling a processing system to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code segments embodied in the medium. Any suitable computer readable medium may be used including a magnetic storage device such as a diskette or a hard disk, or an optical storage device such as a CD-ROM.

It will be understood that the steps of methods discussed are performed in one embodiment by an appropriate processor (or processors) of a processing (i.e., computer) system executing instructions (code segments) stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Thus, while there has been described what is believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

I Claim:

1. A method of resizing, in an imaging application, a planar representation of a 3D object including a plurality of areas each corresponding to one of a plurality of surface areas of the 3D object, and where the imaging application has access to information regarding coincident edges and/or points of the plurality of areas based on their relationship in the 3D object, the method comprising:
accepting a scaling parameter, where said scaling parameter corresponds to a scaling of the 3D object along an axis of the 3D object; and
forming a scaled planar representation of the 3D object, where said forming includes resizing and/or translating one or more of the plurality of areas of the planar representation of a 3D object based on the information regarding coincident edges and/or points of the plurality of areas.

2. The method of claim 1, wherein said accepting a scaling parameter includes accepting a parameter for scaling one area corresponding to a surface of the 3D object.

3. The method of claim 2, wherein the information regarding edges and/or points of the plurality of areas is stored as metadata.

4. The method of claim 3, wherein said forming a scaled planar representation accepting a scaling parameter includes accepting a parameter for scaling one area corresponding to a surface of the 3D object.

5. The method of claim 3, wherein said forming a scaled planar representation accepting a scaling parameter includes sequentially scaling areas based on said scaling of one area.

6. The method of claim 1, wherein, during said forming, the relative position of the plurality of areas of the planar representation is maintained.

7. A computer programmed to:
execute a program to read a file comprising information including
information regarding spacing of points and/or edges of a plurality of planar shapes, where each of said planar shapes corresponds to an area of 3D object, and
information relating coincident points and/or edges for one of the plurality of planar shapes with at least one other planar shape of the plurality of shapes; and
display the planar representation of the 3D object on a computer display.

8. The computer of claim 7, wherein the imaging application is adapted to accept a scaling parameter for one or more points and/or edges, and display a scaled planar representation of the 3D object, where said forming includes resizing and/or translating one or more of the plurality of areas of the planar representation of a 3D object based on the information.

9. The computer of claim 7, wherein, during said forming, the displayed scalar representation of a 3D object includes maintain the relative position of the plurality of areas of the planar representation.
